(19) United States
(12) Patent Application Publication
(10) Pub. No.: US 2004/0239895 A1
(43) Pub. Date: Dec. 2, 2004

(54) Rear projector for projecting an image from a rear side of a screen

(76) Inventor: Masayuki Inamoto, Saitama (JP)

Correspondence Address: Arnold International, P.O. BOX 129, Great Falls, VA, 22066, US

(21) Appl. No.: 10/849,924

(22) Filed: May 21, 2004

(30) Foreign Application Priority Data
May 27, 2003 (JP) 2003-148714

(51) Int. Cl. G03B 21/22

(52) U.S. Cl. 353/98

(57) ABSTRACT

An optical unit comprises a light source, an illumination optical system, a color-separation optical system, liquid-crystal displays, a cross dichroic prism, and a projection optical system. The projection optical system includes a first projector-lens group, a reflex mirror for perpendicularly bending an optical path of projection light, and a second projector-lens group. Illumination light emitted from the light source is parallel with a screen surface and an optical axis of the first projector-lens group. When the optical unit is rotated around a parallel axis with an optical path of the illumination light, a posture of the light source is kept in a horizontal state.

### BACKGROUND OF THE INVENTION

1. Field of the Invention

The present invention relates to a rear projector for projecting an image form a rear side of a screen.

2. Description of the Related Art

In recent years, a rear projection television draws attention as a large-sized display device. The rear projection television is constituted of a screen built in a housing, a plane mirror disposed behind the screen, and an optical unit (projector) for emitting projection light toward the plane mirror. The optical unit comprises an illumination optical system, image displays and a projection optical system. The illumination optical system produces uniform illumination light from white light of a high-intensity light source. The image displays form an original image by modulating the illumination light. The projection optical system enlarges and radiates the projection light having image information.

The optical unit is disposed at a position where the projection light is upwardly radiated toward the plane mirror inclined relative to the screen and placed at the rear side thereof. As to the rear projection television, a depth of the housing is reduced by standing the plane mirror as parallel as possible with a surface of the screen in comparison with a case in that an inclination angle of the plane mirror is 45 degrees. Therefore, the optical unit is usually built in such as to confront the plane mirror and such as to radiate the projection light in an oblique-and-upward direction (see Japanese Patent Laid-Open Publication No. 2002-141025, for instance).

Meanwhile, since the housing inside of the rear projection television is substantially hollow, the illumination optical system and the projection optical system may be freely designed. Thus, the rear projection television is prevented from being markedly restricted about its size and its form such as a general front projector. It is possible to commonly use not only components of the respective optical systems but also the optical unit itself for products having different external shapes of the housing and different sizes of the screen.

As to discharge-type light sources to be used for projectors, there are a metal halide lamp, a super-high pressure mercury lamp and so forth. These light sources, however, have problems in that luminescent intensity deteriorates and a lifetime of the lamp becomes short when an arc between electrodes falls and rises due to an influence of gravity such as described in the above-noted Publication No. 2002-141025. In order to commonly use the optical unit, designing is restricted so as not to change a disposition posture which is proper to the light source to be used. For example, when the inclination angle of the plane mirror is changed for the purpose of reducing a depth of the rear projection television, it is required to use the light source being proper to oblique setting. When the projection light is radiated in a horizontal direction or in a perpendicular direction, it is required to use the light source being proper to horizontal setting or perpendicular setting. Consequently, in a conventional way, there is a disadvantage that it is impossible to commonly use the light source when commonly using the optical unit of the projection television.

### SUMMARY OF THE INVENTION

In view of the foregoing, it is a primary object of the present invention to provide a rear projector in which a light source is contained so as to invariably keep a disposition posture thereof without regard to a different screen size and a different elevation angle of projection light.

It is a second object of the present invention to provide a rear projector in which optical units having an identical structure are commonly used without deteriorating lamp intensity and shortening a lifetime.

In order to achieve the above and other objects, the rear projector according to the present invention includes an optical unit comprising a light source, a light modulator and a projection optical system. Incidentally, in the rear projector, an image is projected from a rear side of a screen. The projected image is viewed from a front side of the screen.

The light source emits illumination light toward an optical path being parallel with a screen surface. The light modulator optically modulates the illumination light pixel by pixel to emit projection light. The projection optical system enlarges the projection light and radiates it toward the screen. The projection light is transmitted in a direction being perpendicular to the illumination-light emitting direction. An elevation angle of the projection light is changed by rotating the optical unit around the optical path of the illumination light, which is parallel with the screen surface, without changing a disposition posture of the light source.

In a preferred embodiment, the projection optical system is provided with a reflex optical member for perpendicularly bending an optical path of the projection light. Further, a plane mirror for reflecting the projection light toward the screen is disposed between the screen and the projection optical system. The elevation angle of the projection light is adapted to be changeable relative to the plane mirror having a different inclination angle, without changing the disposition posture of the light source.

It is preferable that the projection optical system is constituted of a first lens group, a second lens group and the reflex optical member. The first lens group has a first optical axis being parallel with the optical path of the illumination light. The second lens group has a second optical axis being perpendicular to the first optical axis of the first lens group. The reflex optical member is disposed between the first and second lens groups.

According to the rear projector of the present invention, the transmission direction of the projection light may be properly changed on a plane being perpendicular to a shorter side of the screen or a longer side thereof. Moreover, the optical unit is commonly used without regard to a screen size, a size of the plane mirror and the inclination angle of the plane mirror. This is advantageous for the cost and so forth. Since the projection optical system contains the reflex optical member for bending the optical path of the projection light, it is possible to reduce its size in comparison with a case that the reflex optical member is disposed at a screen side of the projection optical system. Further, it is possible to lessen a protrusion of the projection optical system having an L-like shape in comparison with a case that the reflex optical member is disposed at a display side of the projection optical system.

### BRIEF DESCRIPTION OF THE DRAWINGS

The above objects and advantages of the present invention will become apparent from the following detailed description of the preferred embodiments of the invention when read in conjunction with the accompanying drawings, in which:

FIG. 1 is a schematic illustration showing a rear projector;

FIG. 2 is a perspective view showing a disposition of a screen, a plane mirror and an optical unit;

FIG. 3 is a perspective view showing the inside of the optical unit;

FIG. 4 is a schematic illustration showing a second embodiment of the rear projector using the same optical unit; and

FIG. 5 is a perspective view showing the rear projector in which the optical unit has a different structure.

### DETAILED DESCRIPTION OF THE PREFERRED EMBODIMENT(S)

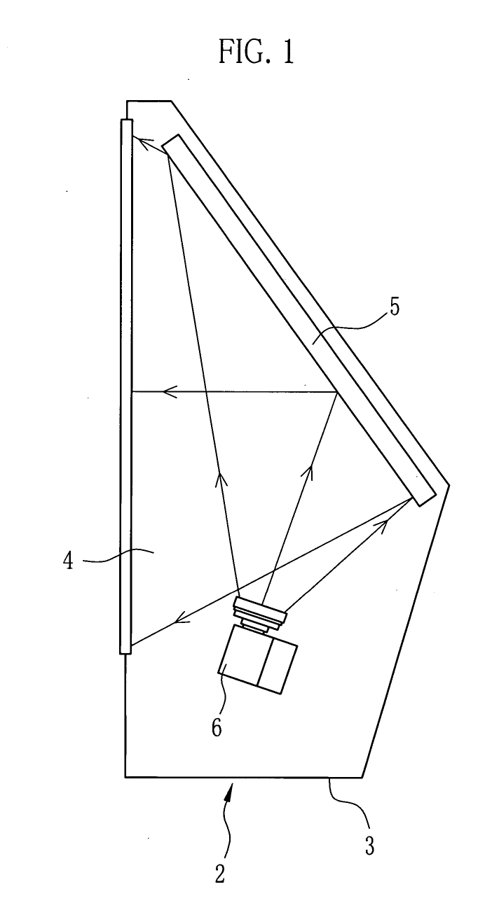

In FIG. 1, a rear projector 2 comprises a screen 4 disposed at a front side of a housing 3, a plane mirror 5 disposed behind the screen 4, and an optical unit 6. The plane mirror 5 is obliquely set such that its inclination angle relative to the screen 4 is less than 45 degrees. The optical unit 6 has a built-in projection lens whose optical axis inclines against the screen 4. Projection light obliquely-and-upwardly radiated from the optical unit 6 is reflected by the plane mirror 5 and is transmitted to the back of the screen 4. A reversed projection image is projected onto the back of the screen 4, and an erect projection image is viewed from the front of the screen 4.

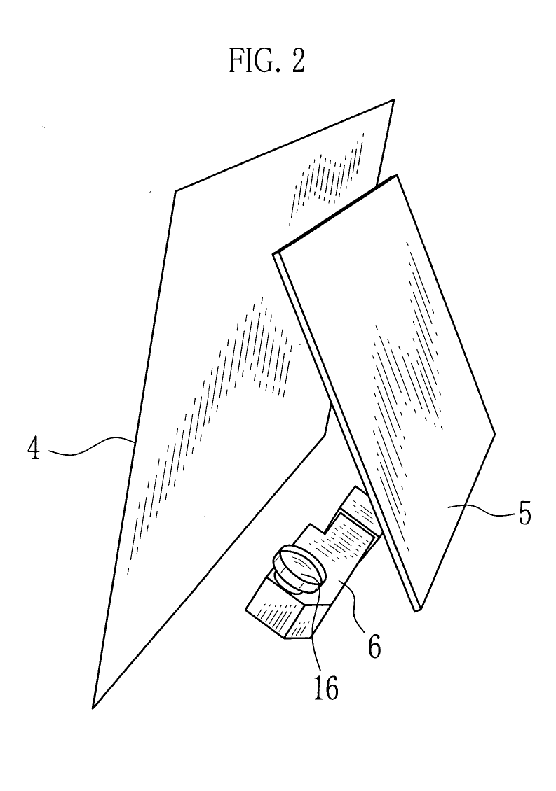

In FIG. 2, the screen 4 has an oblong rectangular shape. A longer side of the screen 4 is parallel with a horizontal direction, and a shorter side thereof is parallel with a vertical direction. The plane mirror 5 is inclined in a state that an upper side thereof is near to the screen 4 along a reference axis being parallel with the longer side of the screen 4. The plane mirror 5 is disposed so as to reduce a depth size of the housing 3. Incidentally, although the plane mirror 5 is smaller than the screen 4, a necessary size thereof may be reduced as the plane mirror 5 is disposed more separately from the screen 4 and more near to the optical unit 6.

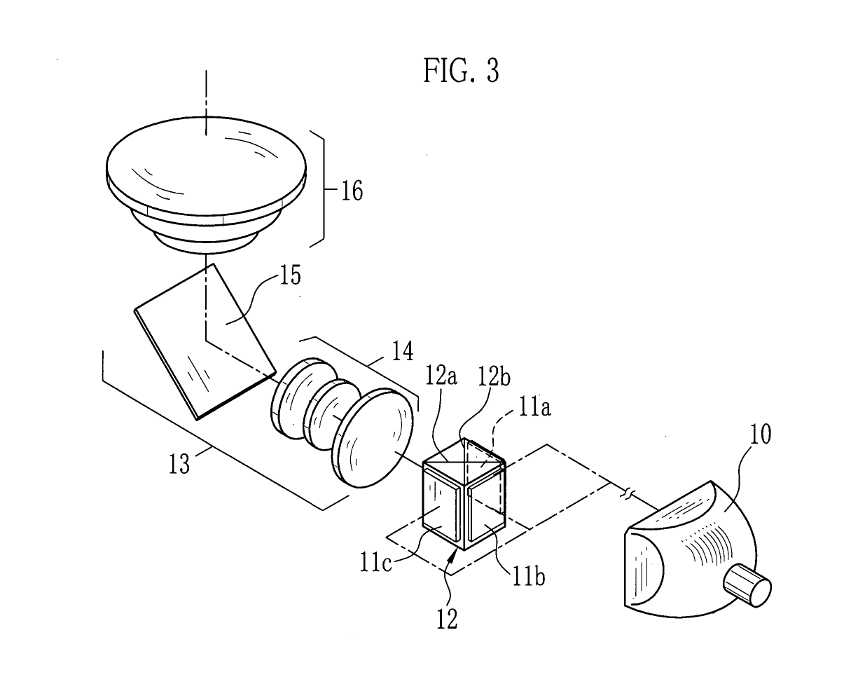

In FIG. 3, the optical unit 6 comprises a light source 10, an illumination optical system (not shown), and a color-separation optical system (not shown), which are incorporated in a unitized state. The light source 10 is for high-intensity illumination. The illumination optical system converts the white light, which is emitted from the light source 10 in a parallel direction with the longer side of the screen 4, into uniform illumination light. The color-separation optical system divides the white light into three-primary-color light of Red(R), Green(G) and Blue(B). By the way, with respect to a polarization conversion element and so forth, illustration and description thereof are omitted. Liquid-crystal displays 11a, 11b and 11c are respectively disposed at each optical path of the illumination lights separated into three colors. The liquid-crystal displays 11a to 11c comprises a large number of liquid-crystal pixels arranged in matrix and having an XGA (Extended Graphics Array) size, for example. The respective pixels of the liquid-crystal display adjust a transmission amount of the illumination light of each color. The liquid-crystal displays 11a, 11b and 11c constitute a light modulator.

By means of the three displays 11a to 11c, the illumination light of each color is modulated to the projection light having information of an image whose aspect ratio is 4 to 3. The liquid-crystal displays are positioned so as to surround three sides of a cross dichroic prism 12. The liquid-crystal displays are disposed in a lengthwise posture and in a state that longer sides of rectangular display surfaces thereof are parallel with each other. Regarding the liquid-crystal displays 11aand 11c respectively disposed at the red optical path and the blue optical path, shorter sides thereof are parallel with the longer side of the screen 4.

The cross dichroic prism 12 is provided with a red-light reflection coating 12a and a blue-light reflection coating 12b for reflecting the red projection light and the blue projection light respectively. The red projection light having passed through the liquid-crystal display 11a is reflected by the red-light reflection coating 12a. The blue projection light having passed through the liquid-crystal display 11c is reflected by the blue-light reflection coating 12b. Meanwhile, the green projection light having passed through the liquid-crystal display 11b passes through the respective coatings. The projection light of the respective colors are synthesized as the projection light having full-color image information when passing through the cross dichroic prism 12.

The projection light transmitted from the cross dichroic prism 12 enters a projection optical system 13 constituted of a first projector-lens group 14, a flat reflex mirror 15 and a second projector-lens group 16. The first projector-lens group 14 has an optical axis being parallel with the longer side of the screen 4. The reflex mirror 15 is disposed so as to incline at 45 degrees. The second projector-lens group 16 radiates the projection light toward the plane mirror 5. By the way, instead of the reflex mirror 15, it is possible to use a rectangular prism whose inclination surface is formed with a reflection coating.

The reflex mirror 15 perpendicularly bends the optical path of the projection light transmitted from the cross dichroic prism 12. The reflex mirror 15 and the plane mirror 5 are disposed such that inclination postures thereof are different with each other so as to be skewed. The projection light is adapted to be deflected by 90 degrees. In other words, the lengthwise image formed by the liquid-crystal displays 11a to 11c disposed in the lengthwise posture is projected to the screen 4 in an oblong condition.

Next, an operation of the rear projector 2 is described bellow. Upon driving the light source 10 horizontally disposed, the white illumination light is emitted toward the horizontal optical path of the illumination light, which is parallel with the longer side of the screen 4. The illumination light emitted from the light source 10 is separated into the red illumination light, the green illumination light and the blue illumination light by means of the well-known color-separation optical system to enter the liquid-crystal displays 11a to 11c disposed at the illumination-light optical paths of the respective colors. The illumination light of the respective colors passing through the liquid-crystal displays 11a to 11c are modulated to the projection light having the image information. The modulated projection light enters the cross dichroic prism 12.

Inside the cross dichroic prism 12, the red and blue reflection coatings 12a and 12b reflect the red projection light and the blue projection light respectively, and the green projection light passes through the respective reflection coatings. The projection light of three colors are synthesized before entering the projection optical system 13. The synthesized projection light passes through the first projector-lens group 14 and is reflected by the reflex mirror 15. After that, the projection light passes through the second projector-lens group 16 and is radiated toward the plane mirror 5. The projection light emitted from the optical unit 6 is reflected by the plane mirror 5 to form an oblong image on the screen 4. It is possible to view the enlarged projection image from the front side of the screen 4.

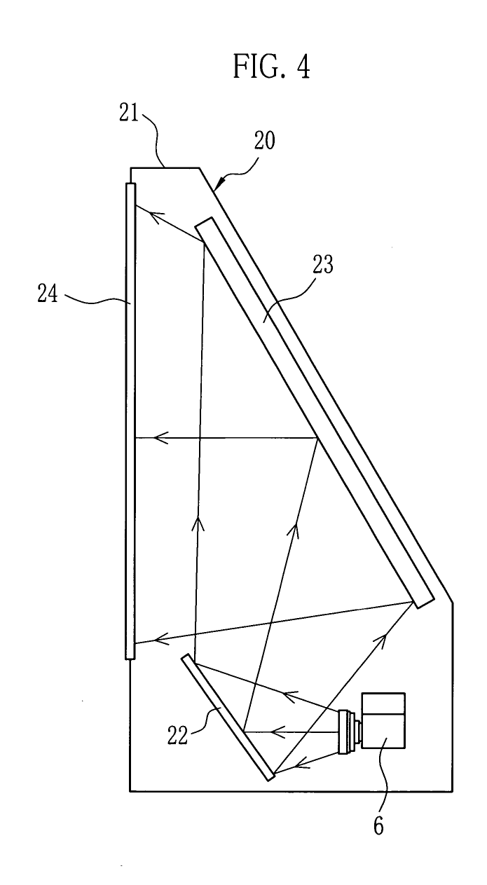

In the meantime, FIG. 4 shows a rear projector 20 in which the optical unit 6 being identical with that of the rear projector 2 is contained so as to be rotatable around a horizontal axis. The optical unit 6 horizontally emits the projection light toward the front of the apparatus. A housing 21 contains a first plane mirror 22 and a second plane mirror 23. The light emitted from the optical unit 6 toward the front of the apparatus is reflected by the first and second plane mirrors 22 and 23 to advance along a Z-shaped optical path. And then, an image is formed on a screen 24 having a larger size in comparison with the screen 4. A longer projection distance is secured by the two plane mirrors so that a projection magnification is raised. In the rear projector 20, the light emitted from the optical unit 6 is reflected with the even-number plane mirrors by even-number times. The image formed by the liquid-crystal displays of the optical unit 6 is reversed beforehand in the longer-side direction of the image to be formed by the rear projector. However, description regarding this is omitted.

Since the transmission direction of the projection light is properly changed on a plane being perpendicular to the longer side of the screen, it is possible to commonly use the optical unit 6 for the rear projector having a different screen size and a different size of the plane mirror.

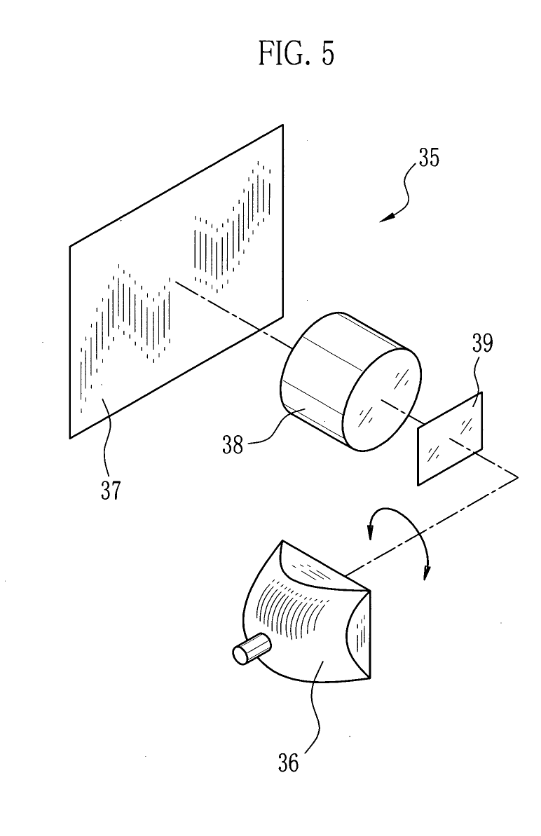

In the above embodiment, the transmission-type liquid-crystal display is used as the image display. However, this is not exclusive. The present invention may be similarly adopted to an image display of a reflection-type liquid-crystal display (LCOS for instance), a digital micro mirror device and so forth, which require the illumination light source. Moreover, the number of the image displays is not exclusive. The present invention may be similarly adopted to rear projector of a single-plate type and a three-plate type. For example, a rear projector 35 shown in FIG. 5 is provided with an illumination-light source 36 horizontally disposed. An optical path of the illumination light is parallel with a longer-side of a rectangular screen 37. An optical axis of a projector lens 38 is perpendicular to the optical path of the illumination light. A display surface of an image display 39 is parallel with the optical path of the illumination light. By revolving the projector lens 38 and the image display 39 around a center axis of the illumination-light optical path, it is possible to change an elevation angle of the projection light without changing the disposition posture of the illumination light source 36.

When the light source favorable for the horizontal disposition is used as the light source such as described in the above embodiment, the transmission direction of the projection light is set on a plane being perpendicular to the longer side of the screen. By contrast, in the rear projector wherein the transmission direction of the projection light is changeable on a plane being perpendicular to the shorter side of the screen, the elevation angle of the projection light relative to the screen surface may be properly changed by using the light source favorable for the vertical posture, which is the super-high pressure mercury lamp for instance.

In the forgoing embodiments, the plane mirrors 5, 22 and 23 are used as catoptric members for reflecting the projection light. However, instead of the plane mirror, it is possible to use an asphere mirror and a reflecting prism as the catoptric member.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A rear projector in which an image is projected from a rear side of a screen and said image is viewed from a front side of said screen, said rear projector comprising:
a light source for emitting illumination light toward an optical path being parallel with a surface of said screen;
a light modulator for optically modulating said illumination light pixel by pixel; and
a projection optical system for enlarging and radiating projection light, which is exited from said light modulator, toward said screen, said projection optical system radiating said projection light in a direction being perpendicular to an emission direction of said illumination light.

2. A rear projector according to claim 1, wherein said projection optical system comprises a reflex optical member for perpendicularly bending the projection light exited from said light modulator.

3. A rear projector according to claim 2, further comprising:
a first catoptric member disposed between said screen and said projection optical system, said first catoptric member reflecting the projection light from said projection optical system toward said screen.

4. A rear projector according to claim 3, further comprising:
a least one additional catoptric member disposed between said first catoptric member and said projection optical system, said additional catoptric member reflecting the projection light from said projection optical system toward said first catoptric member.

5. A rear projector according to claim 3, wherein said projection optical system includes a first lens group having a first optical axis being parallel with said optical path, and a second lens group having a second optical axis being perpendicular to said first optical axis, said reflex optical member being disposed between said first and second lens groups.
